(19) United States
(12) Patent Application Publication
(10) Pub. No.: US 2005/0128742 A1
(43) Pub. Date: Jun. 16, 2005

(54) Light generating device that self centers within a lumen to render photodynamic therapy

(76) Inventors: James C. Chen, Bellevue, WA (US); Zihong Guo, Bellevue, WA (US); Gary Lichttenegger, Woodinville, WA (US); David B. Shine, Sammamish, WA (US); Phillip Burwell, Snohomish, WA (US)

Correspondence Address: Michael C. King;LAW OFFICES OF RONALD M. ANDERSON, 600 - 108th Avenue N.E., Suite 507, Bellevue, WA, 98004, US

(21) Appl. No.: 10/888,567

(22) Filed: Jul. 8, 2004

Related U.S. Application Data
(63) Continuation-in-part of application No. 10/799,357, filed on Mar. 12, 2004.
(60) Provisional application No. 60/485,858, filed on Jul. 8, 2003.
(60) Provisional application No. 60/455,069, filed on Mar. 14, 2003.

(51) Int. Cl. F21S 2/00

(52) U.S. Cl. 362/227

(57) ABSTRACT

A light generating device for illuminating tissue adjacent to a body lumen while a distal end of the device is centered in the lumen, to render photodynamic therapy. The device can either occlude or displace bodily fluid, both without the use of a balloon. In one embodiment, a flushing lumen has a port adjacent to an array of light sources, to displace bodily fluid that might otherwise absorb light. Another embodiment employs a centering member that moves between a first position and a second position. The centering member centers the device in the lumen and preferably is formed of a shape memory material. In yet another embodiment, the device includes an outer sheath and an inner member that are independently positionable, enabling the centering member to be selectively positionable. The centering member can be non porous, such that the centering member also occludes fluid flow.

### RELATED APPLICATIONS

This application is based on a prior copending provisional application, Ser. No. 60/485,858, filed on Jul. 8, 2003, the benefit of the filing date of which is hereby claimed under 35 U.S.C. §119(e), and is also a continuation-in-part of a prior copending application, Ser. No. 10/799,357, filed on Mar. 12, 2004, which itself is based on a prior copending provisional application, Ser. No. 60/455,069, filed on Mar. 14, 2003, the benefits of the filing dates of which are hereby claimed under 35 U.S.C. §119(e) and 35 U.S.C. §120.

### FIELD OF THE INVENTION

The present invention generally relates to a method and apparatus for using light to diagnose and treat tissue, and more specifically, to a method and apparatus to treat or diagnose tissue accessible via a cavity, duct, vessel, or other lumen of a body, wherein the apparatus is able to center itself within the lumen, and to prevent blood flow in the vessel from interfering with light transmission to the tissue, all without the use of an inflatable balloon.

### BACKGROUND OF THE INVENTION

Photodynamic therapy (PDT) is a process whereby light of a specific wavelength or waveband is directed to tissue, to enable diagnosis or treatment. The tissue is rendered photosensitive through the administration of a photoreactive or photosensitizing agent having a characteristic light absorption waveband. In PDT, the photoreactive agent is first administered to a patient, typically by intravenous injection, oral administration, or by local delivery to the treatment site. Abnormal tissue in the body is known to selectively absorb certain photoreactive agents to a much greater extent than normal tissue. Once the abnormal tissue has absorbed or linked with the photoreactive agent, the abnormal tissue can then be diagnosed or treated by administering light having a wavelength or waveband corresponding to the absorption wavelength or waveband of the photoreactive agent. The treatment can result in the necrosis of the abnormal tissue.

PDT has proven to be very effective in destroying abnormal tissue, such as cancer cells, and has also been proposed for the treatment of vascular diseases, such as atherosclerosis and restenosis due to intimal hyperplasia. In the past, percutaneous transluminal coronary angioplasty (PTCA) has typically been performed to treat atherosclerotic cardiovascular diseases. A more recent treatment based on the use of drug eluting stents has reduced the rate of restenosis in some diseased vessels. As effective as such therapies are, a new form of therapy is needed for treating peripheral arterial disease and more problematic coronary diseases, such as vulnerable plaque, saphenous vein bypass graft disease, and diffuse long lesions.

As noted above, the objective of PDT may be either diagnostic or therapeutic. In diagnostic applications, the wavelength of light is selected to cause the photoreactive agent to fluoresce, thus yielding information about the tissue without damaging the tissue. In therapeutic applications, the wavelength of light delivered to the tissue treated with the photoreactive agent causes the photoreactive agent to undergo a photochemical reaction with oxygen in the localized tissue, which is believed to yield free radical species (such as singlet oxygen) that cause localized cell lysis or necrosis. The central strategy to inhibit arterial restenosis using PDT, for example, is to cause a depletion of vascular smooth muscle cells, which are a source of neointima cell proliferation (see, Nagae et al., Lasers in Surgery and Medicine 28:381-388, 2001). One of the advantages of PDT is that it is a targeted technique, in that selective or preferential delivery of the photoreactive agent to specific tissue enables only the selected tissue to be treated. Preferential localization of a photoreactive agent in areas of arterial injury, with little or no photoreactive agent delivered to healthy portions of the arterial wall, can therefore enable highly specific PDT ablation of arterial tissue.

Light delivery systems for PDT are well known in the art. Delivery of light from a light source, such as a laser, to the treatment site has typically been accomplished through the use of a single optical fiber delivery system with special light-diffusing tips affixed thereto. Exemplary prior art devices also include single optical fiber cylindrical diffusers, spherical diffusers, micro-lensing systems, an over-the-wire cylindrical diffusing multi-optical fiber catheter, and a light-diffusing optical fiber guidewire. Such prior art PDT illumination systems generally employ remotely disposed high power lasers or solid state laser diode arrays, coupled to optical fibers for delivery of light to a treatment sight. The disadvantages of using laser light sources include relatively high capital costs, relatively large size, complex operating procedures, and the safety issues inherent when working with high power lasers. Accordingly, there is a substantial need for a light generating system that does not include a laser, and which generates light at the treatment site instead of at a remote point. For vascular applications of PDT, it would be desirable to provide a light-generating apparatus having a minimal cross-section, a high degree of flexibility, and compatibility with a guidewire, so the light-generating apparatus can readily be delivered to the treatment site through a vascular lumen. Such an apparatus should also deliver light uniformly to the treatment area.

For vascular application of PDT, it would further be desirable to provide a light-generating apparatus that is easily centered within a blood vessel, and which is configured to prevent light absorbent material, such as blood, from being disposed in the light path between the target tissue and the apparatus. Typically, an inflatable balloon catheter that matches the diameter of the blood vessel when the balloon is inflated is employed for centering apparatus within a vessel. Such devices also desirably occlude blood flow, enabling the light path to remain clear of obstructing blood. However, when a balloon catheter is used with a light generating device, heat emitted from the light-generating device may damage some of the polymer materials that are normally used for the balloon. A further disadvantage of the balloon catheter is that the balloon may damage a vessel wall when inflated. The balloon adds mass and increase the overall outer diameter of the light-generating device, which decreases flexibility and provides a disadvantage when treating a tightly stenotic lesion or a lesion in a tortuous vessel or lumen. Furthermore, for treating a range of vessel diameters and lesions lengths within blood vessels, multiple balloon sizes may be required. Therefore, it would be desirable to provide a light generating device usable in a vascular system, which has the ability to center itself within a vessel, and which also has the ability to occlude blood flow, but without using a balloon.

### SUMMARY OF THE INVENTION

The present invention encompasses light generating devices for illuminating portions of vascular tissue to administer PDT. Each embodiment includes one or more light sources adapted to be positioned inside a body cavity, a vascular system, or other body lumen. While the term “light source array” is frequently employed herein, because particularly preferred embodiments of this invention include multiple light sources arranged in a radial or linear configuration, it should be understood that a single light source can also be employed within the scope of this invention. Using a plurality of light sources enables larger treatment areas to be illuminated. Light emitting diodes (LEDs) are particularly preferred as light sources, although other types of light sources can be employed, as described in detail below. The light source that is used is selected based on the characteristics of a photoreactive agent with which the apparatus is intended to be used, since light of incorrect wavelengths or waveband will not cause the desired reaction by the photoreactive agent. An array of light sources can include light sources that provide more than one wavelength or produce light that covers a waveband. Linear light source arrays are particularly useful to treat elongate portions of tissue within a lumen. Light source arrays used in this invention can also optionally include reflective elements to enhance the transmission of light in a preferred direction. Each embodiment described herein can beneficially include expandable members to occlude blood flow and to enable the apparatus to be centered in a blood vessel.

A key aspect of the light generating device of the present invention is that it includes elements that enable a distal end of the device to be centered in a body lumen, and which can either occlude or displace bodily fluid, without the use of an inflatable member, such as a balloon. Displacing or occluding bodily fluids, such as blood, from a body lumen into which such a device is introduced, is important because the presence of such bodily fluids (in particular, the presence of blood) will likely interfere with the transmission of light (from a light source associated with the device) to a target area (generally a lesion in the wall of the lumen). If light cannot reach the treatment area, the treatment will not be carried out. Thus, one aspect of the invention is directed to a light generating device having an elongate flexible body defining at least one lumen, a light source array disposed at a distal end of the elongate flexible body, and means for reducing an amount of bodily fluid adjacent to the light source array when the device is positioned within a body lumen, thereby reducing the light from the light source array that is absorbed by such bodily fluid, and increasing the light from the light source array that reaches a wall of the body lumen. Unlike the prior art, in the present invention, an inflatable member is not used to carry out this function.

In one embodiment, the means comprises a flushing lumen adapted to introduce a flushing fluid into the body lumen to displace bodily fluid that might otherwise absorb light generated by the light source array.

In another embodiment, the means includes a centering member movable between at least a first position and a second position, the first position being characterized by the centering member generally conforming to the elongate flexible body, and the second position being characterized by the centering member generally extending from the elongate flexible body to the wall of the body lumen, so that the centering member both centers the distal end of the device, and substantially occludes a flow of the bodily fluid in the body lumen.

The centering member preferably comprises a shape memory material that moves between the first and second positions in response to a change in temperature. The light source array can provide the required heat to change the temperature of the shape memory material, or a heating element can be included to provide the required heat. If it is not necessary to occlude the flow of bodily fluid, and it is only desired to center the distal end of the device in the body lumen, the centering member can be replaced with a shape memory member that is porous, so that when the shape memory member is deployed, the device is centered in the lumen, and bodily fluid, such as blood, will still flow past the shape memory member.

In one embodiment, an outer sheath is movable relative to an inner member of the elongate flexible body. The centering member is moved between the first and second positions by moving the outer sheath relative to the inner member. In this embodiment, the centering member preferably comprises a polymer coated mesh that is coupled to both the inner member and the outer sheath, and the centering member is deployed as the outer sheath is advanced toward the distal end of the device. In another embodiment, the centering member comprises a shape memory material that in an un-deployed position, is disposed between the inner member and the outer sheath. To deploy the centering member, the outer sheath is withdrawn relative to the distal end of the device, thus uncovering the centering member, which no longer being restrained by the outer sheath, springs back to its deployed shape.

Another aspect of this invention is directed to a multi-lumen catheter including a guidewire lumen and a flushing lumen. Once introduced into a body lumen, the guidewire is removed, and a light emitting array is introduced via the guidewire lumen. The flushing lumen displaces bodily fluid while the light emitting array irradiates the body lumen walls. A light diffusing tip is optionally added to a distal end of the device. Centering members consistent with those described above can be beneficially included in such embodiments of the device.

Still another aspect of the invention is directed to a light generating device having an elongate flexible body defining at least one lumen, an array of light sources disposed at a distal end of elongate flexible body, and various embodiments of a selectively activatable centering member, which in a first position, does not substantially occlude a flow of bodily fluid in a lumen, and in a second position, substantially occludes a flow of bodily fluid in the lumen. The centering member is disposed such that a flow of bodily fluid past an array of light sources is reduced, thereby reducing the amount of bodily fluid that can undesirably block or absorb light. Such blocked or absorbed light reduces the amount of light that can reach lesions on the walls of the lumen. The centering member also functions to center a distal end of the light-generating device within a body lumen. Each of these embodiments achieves the occlusion and centering function using structures distinguishable from an inflatable member, the centering member being generally consistent with one of the embodiments described above. While it is preferred for the centering member described herein to be sufficiently solid to actually occlude the flow of bodily fluid, it should be noted that if centering alone is desired, but occluding the flow of bodily fluid is not required, the centering member can be configured to be sufficiently porous so that little occlusion of bodily fluid results.

The embodiments described above are preferably used with a photoreactive agent that is introduced into the target area prior to the apparatus being introduced into the blood vessel. However, it will be understood that if desired, the apparatus can optionally include a lumen for delivering a photoreactive agent into the target area. Such an embodiment is likely to be particularly beneficial when uptake of the photoreactive agent into the target tissues is relatively rapid, so that the apparatus does not need to remain in the blood vessel for an extended period of time while the photoreactive agent is distributed into and absorbed by the target tissue.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIGS. 1A-1C schematically illustrate a first embodiment of a light-generating device in accord with the present invention;

FIG. 1D is a cross-sectional view of the light-generating device of FIGS. 1A-1C;

FIG. 2 schematically illustrates a second embodiment of a light-generating device in accord with the present invention;

FIGS. 3A-3D schematically illustrate additional embodiments of a light-generating device, each of which includes a shape memory material;

FIG. 3E is a cross-sectional view of the light-generating device of FIG. 3A;

FIGS. 4A and 4B schematically illustrate an embodiment of a light-generating device that includes a centering member, which moves between a first and a second position, to enable a lumen to be selectively occluded;

FIGS. 5A and 5B schematically illustrate an embodiment of a light-generating device that includes a different implementation of a centering member, which moves between a first and a second position; and

FIG. 5C is a cross-sectional view of the light-generating device of FIG. 5B.

### DESCRIPTION OF THE PREFERRED EMBODIMENTS

Unless otherwise defined, it should be understood that each technical and scientific term used herein and in the claims that follow is intended to be interpreted in a manner consistent with the meaning of that term as it would be understood by one of skill in the art to which this invention pertains. The drawings and disclosure of all patents and publications referred to herein are hereby specifically incorporated herein by reference. In the event that more than one definition is provided herein, the explicitly defined definition controls.

Various embodiments of light-generating devices that are able to center the device within a body lumen and optionally substantially preclude the flow of bodily fluid past a distal portion of the device, and a method for illumination and excitation of photoreactive agents in vessels or other body lumens (i.e., to administer PDT) are described herein. An objective of administering PDT with the invention may be either diagnostic, wherein the wavelength or waveband of the light being produced is selected to cause the photoreactive agent to fluoresce, thus yielding information about the tissue, or therapeutic, wherein the wavelength or waveband of the light delivered to the photosensitized tissue under treatment causes the photoreactive agent to undergo a photochemical interaction in the tissue that yields free radical species, such as singlet oxygen, that results in photosensitized tissue lysing or destruction.

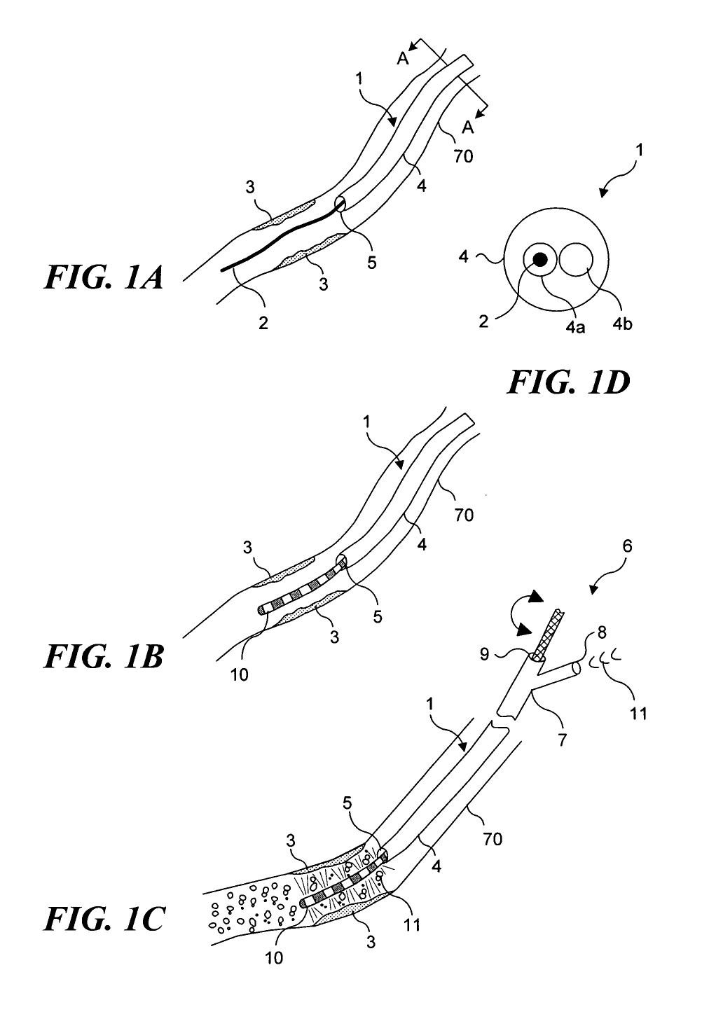

Referring to FIGS. 1A-1D, a light-generating device 1 is formed with a multi-lumen catheter having an elongate flexible body 4 formed from a suitable biocompatible material, such as a polymer or metal. Elongate flexible body 4 includes a distal end 5, a proximal end 6 normally disposed outside a body lumen and configured to enable elongate flexible body 4 to be manipulated (see FIG. 1C in particular) a guidewire lumen 4a, and a flushing lumen 4b (see FIG. 1D for lumens 4a and 4b, FIG. 1D being a cross section taken along section line A-A of FIG. 1A). Guidewire lumen 4a is configured to enable elongate flexible body 4 to be advanced over a guidewire, and flushing lumen 4b is configured to introduce a flushing fluid into a body lumen proximate distal end 5 of elongate flexible body 4. To use light-generating device 1, a guidewire 2 is introduced into an artery 70 (or other body lumen) and advanced until the guidewire is disposed adjacent a lesion 3 (or other treatment area). Elongate flexible body 4 is advanced over guidewire 2 until distal end 5 is adjacent to lesion 3. As shown in FIGS. 1A-1C, elongate flexible body 4 is preferably disposed so that distal end 5 is disposed just proximal of lesion 3.

As shown in FIG. 1B, guidewire 2 is withdrawn and a light-generating array 10 is introduced into guidewire lumen 4a and advanced beyond distal end 5, so that the light-generating array is disposed adjacent to lesion 3. The light-generating array may include one or more LEDs coupled to conductive traces that are electrically connected to leads extending proximally through a lumen of light-generating device 1 to an external power supply and control device (not shown). As an alternative to LEDs, other sources of light maybe used, such as, organic LEDs, superluminescent diodes, laser diodes, fluorescent light sources, incandescent sources, and light emitting polymers. While not specifically shown, it should be understood that elongate flexible body 4 can include a dedicated lumen for light-generating array 10, so that guidewire 2 need not be removed to introduce light-generating array 10. However, the inclusion of an additional lumen increases a diameter of the elongate flexible body, which may not be desirable for devices specifically intended to be inserted into relatively small diameter body lumens.

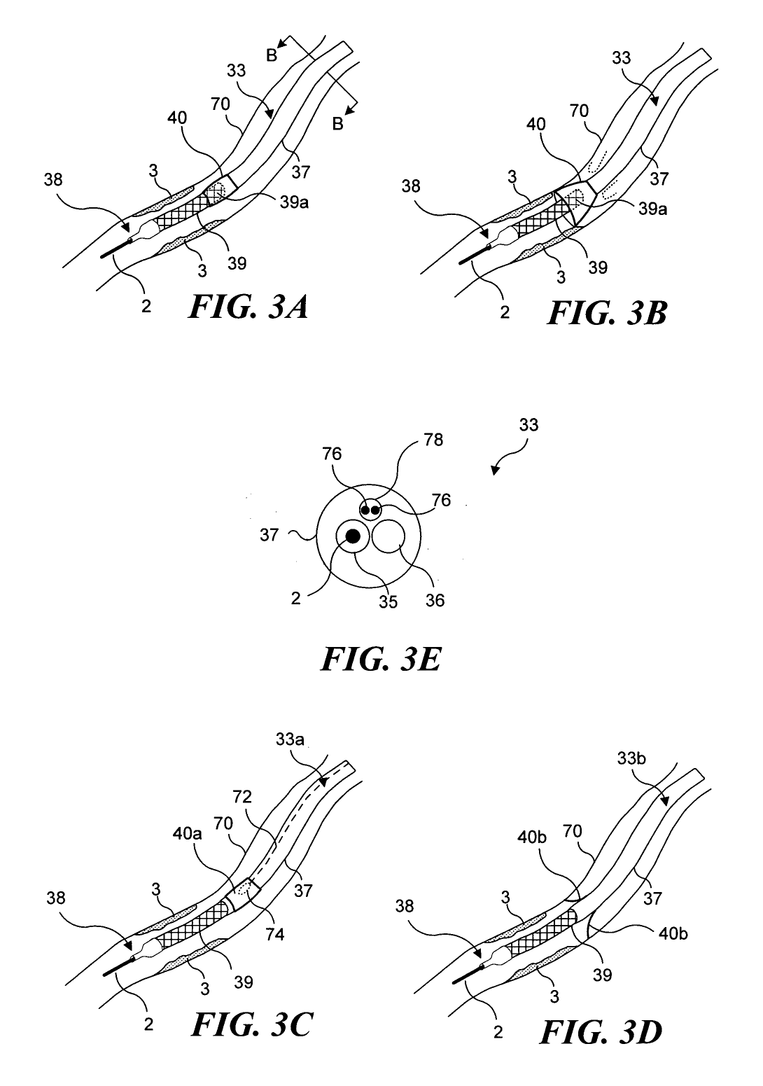

Referring to FIG. 1C, attached to proximal end 6 of elongate flexible body 4 is a Y-adapter 7 defining side entry ports 8 and 9. Side entry port 8 enables a flushing fluid 11 to be introduced into flushing lumen 4b. Flushing fluid 11 exits flushing lumen 4b at distal end 5 of elongate flexible body 4, to displace blood that might otherwise absorb light emitted from light-generating array 10. Light that is thus absorbed is prevented from reaching lesion 3 and providing the desired effect. Flushing fluid 11 may contain heparin and/or a light scattering medium such as Intralipid, or may be optically clear. Side entry port 9 enables light-generating array 10 to be introduced into guidewire lumen 4a, and further enables light-generating array 10 to be independently rotatable within elongate flexible body 4, for improved circumferential light distribution. Elongate flexible body 4 may also be used to deliver a photosensitizer, for example, through flushing lumen 4b, or through another dedicated lumen (not shown). It should be noted that embodiments discussed below in conjunction with FIGS. 3A-5C disclose centering members that enable the distal end of a light-generating device for use in a body lumen to be centered in the body lumen. If desired, such centering members can be implemented using a substantially non porous material, such that the centering member substantially occludes the flow of bodily fluids in the body lumen. It should be understood that such centering members can be beneficially incorporated into light-generating device 1, if desired.

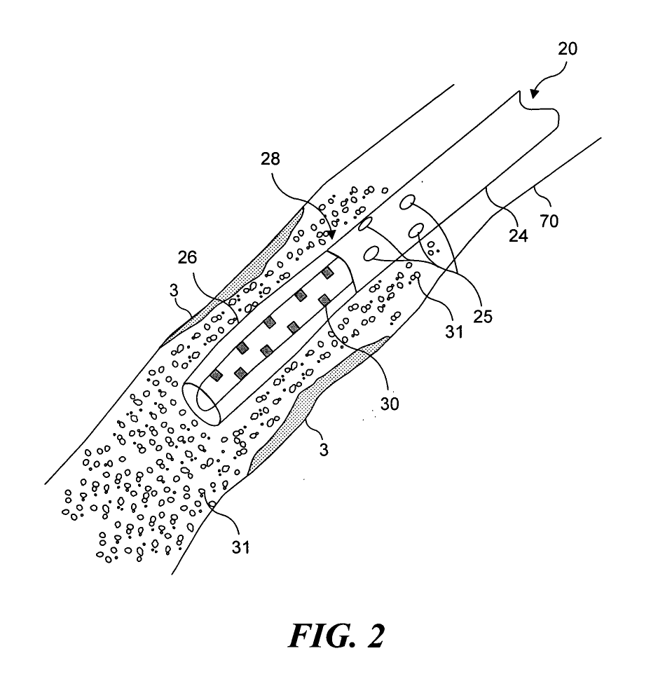

FIG. 2 schematically illustrates a light-generating device 20, in which the light-related elements are integrated into the device, as opposed to being separate elements. Again, light-generating device 20 is formed as a multi-lumen catheter having an elongate flexible body 24 formed from a suitable biocompatible material, such as a polymer or metal. Elongate flexible body 24 also includes a flushing lumen and a guidewire lumen, generally as discussed above. A light diffusing tip 26 is incorporated onto a distal end 28 of elongate flexible body 24. A light-generating array 30 may be threaded through elongate flexible body 24, generally as described above, but instead of extending beyond the elongate flexible body (as does light-generating array 10 in FIGS. 1B and 1C), light-generating array 30 is positioned within light diffusing tip 26. A pressurized flushing liquid 31 exits the flushing lumen of elongate flexible body 24 via a plurality of ports 25 disposed at distal end 28. Flushing fluid 31 displaces blood adjacent to light-generating array 30 in artery 70, thereby reducing the proportion of light that is absorbed and increasing the amount of light reaching lesion 3. Once again, if desired, the centering members discussed in detail below can be beneficially incorporated into light-generating device 20, if desired.

FIGS. 3A-3E, 4A-4B, and 5A-5C each relate to embodiments of light-generating devices that include various embodiments of a centering member disposed on a distal end of the device, which in a first position, substantially conforms to the light generating device, and in a second position, extends outwardly and away from the light generating device to encounter the walls of the body lumen in which the device is deployed, thereby substantially centering the distal end of the device in the body lumen. While it is preferred for the centering members described below to be substantially solid so as to actually occlude the flow of bodily fluid, if centering alone is desired (without also occluding the flow of bodily fluid), each of the following centering members can be configured to be sufficiently porous so that the bodily fluid is able to flow past the centering member. Accordingly, it should be understood that the present invention also encompasses the use of each of the centering members disclosed in conjunction with FIGS. 3A-3E, 4A-4B, and 5A-5C for centering alone, without occlusion. When the centering members are implemented using a substantially non porous material such that both centering and occlusion are achieved, then when the centering member is in the first position, the centering member does not substantially occlude a flow of bodily fluid in the lumen, and when in the second position, the centering member does substantially occlude the flow of bodily fluid in the lumen. Preferably non porous centering members are disposed so that the flow of bodily fluid adjacent or past a light-generating element is reduced, thereby reducing the amount of bodily fluid that undesirably blocks or absorbs light. Light that is blocked by bodily fluid cannot reach lesions on the walls of the lumen. Each embodiment of this invention achieves such centering and occlusion (if desired) using structures that are clearly different than an inflatable member, i.e., different than a balloon.

Referring now to the embodiment of FIGS. 3A-3E, the centering member is implemented using a shape memory material, which moves between the first and second positions in response to a temperature change, generally an increase in temperature (i.e., an application of heat or an input of thermal energy that increases the temperature of the shape memory material above its transition temperature). In FIG. 3A, a light-generating device 33, also formed as a multi-lumen catheter having an elongate flexible body, is introduced into artery 70 and advanced over guidewire 2 to lesion 3, as described above. The elongate flexible body is formed from a suitable biocompatible material, such as a polymer or metal, and includes a proximal shaft 37 and a distal shaft 38. A light-generating array 39 is integrated into distal shaft 38. As discussed above, light-generating array 39 can include one or more LEDs coupled to conductive traces that are electrically connected to leads extending proximally through a lumen of the light-generating device to an external power supply and control device (not shown). As an alternative to. LEDs, other sources of light may be used, as noted above.

Disposed proximal to light-generating array 39 is a centering member 40 formed of shape memory material. Preferably the shape memory material is a polymer; such shape memory materials are known in the art and need not be described herein in detail. As noted above, it is preferred that centering member 40 be substantially non porous, such that centering member 40 both centers the distal end of light-generating device 33, and substantially occludes blood flow in the lumen light-generating device 33 is introduced into. It should be noted that positioning centering member 40 proximal to light-generating array 39 is appropriate when blood flow in the blood vessel naturally moves from a more proximal portion of the apparatus toward a more distal portion. If the blood flow is in the opposite direction, it is appropriate to position centering member 40 distal to light-generating array 39. Of course, if centering member 40 is not intended to occlude blood flow, then centering member 40 simply needs to be disposed at the distal end of light-generating device 33. While light-generating device 33 is being advanced over guidewire 2 to lesion 3, centering member 40 is not deployed. That is, when not deployed, centering member 40 generally conforms to light-generating device 33, and thus, centering member 40 does not substantially interfere with the flow of blood in artery 70 (beyond the interference imposed by light-generating device 33 itself). When light-generating device 33 is positioned adjacent to lesion 3, centering member 40 is deployed, so that centering member 40 expands until it contacts the walls of artery 70, centering the distal end of light-generating device 33, and substantially occluding the flow of bodily fluid. A complete interruption of bodily fluid flow (i.e., blood flow) is not required. While some seepage might interfere with the transmission of light from the light-generating array to the lesion, a small amount of light absorption by the fluid is acceptable. Of course, the less absorption, the less light is required to effect the desired therapeutic or diagnostic result during administration of PDT. To deploy centering member 40, heat is applied to centering member 40. Shape memory polymer material memorizes a certain shape at a certain temperature. The amount of heat required to reach the shape transition temperature is a function of the specific shape memory material employed (and the temperature within the body lumen). Preferably, the amount of heat required sufficiently low to cause thermal damage to surrounding tissue. Note that in FIG. 3A, centering member 40 is not yet deployed, and part of centering member 40 overlays a portion 39a of light-generating array 39. Energizing light-generating array 39 heats centering member 40, causing the centering member to deploy. FIG. 3B illustrates centering member 40 in the deployed position. Once centering member 40 is deployed, a flushing fluid can be introduced distal of the centering member to displace any residual bodily fluid, and to maintain a clear light transmission path between the light-generating array and treatment area (i.e., lesion 3). As shown, centering member 40 is generally cone shaped when deployed. Those of ordinary skill in the art will recognize that other shapes can be implemented, and the shape of centering member 40 is considered to be exemplary, rather than limiting in regard to the present invention.

FIG. 3C illustrates a related embodiment, in which a heater, rather than the light-generating array, is used to change the temperature of the shape memory material comprising the centering member. In FIG. 3C, a light-generating device 33a is shown. A centering member 40a is disposed proximal to light-generating array 39, although no overlap of light-generating array 39 and centering member 40a is required. Instead, a heating element 74 is disposed adjacent to centering member 40a, so that energizing heating element 74 causes centering member 40a to deploy. Electrical lead 72 couples heating element 74 to an external power source. Preferably, heating element 74 is a resistive heating element, such as a nichrome wire, although other types of heating elements can be employed. Most preferably, the heating element is incorporated into the centering member. For example, the heating element can be configured as a nichrome mesh that is incorporated inside the centering member, so that heat is continuously provided to the centering member to maintain the shape memory material at the temperature required to maintain its deployed shape.

FIG. 3D illustrates yet another embodiment of a centering member 40b formed of a shape memory material. In FIG. 3D, a light-generating device 33b is shown. Centering member 40b comprises a plurality of flaps that are arranged around the circumference of light-generating device 33b. The flaps can be spaced sufficiently close together so that substantially all bodily fluid flow past the light-generating device is occluded when centering member 40b is deployed. If, however, it is desired to use the flaps of the shape memory material only to center the distal end of light-generating device 33b within artery 70 and it is not necessary to also occlude the flow of bodily fluids, the flaps can be spaced farther apart.

FIG. 3E is a cross-sectional view of light-generating device 33, taken along section line B-B of FIG. 3A, illustrating that light-generating device 33 includes a guidewire lumen 35 and a flushing lumen 36, whose functions have been described in detail above. Also included is an electrical lumen 78, which convey electrical leads 76 that are used to energize light-generating array 39 (and, if used, heating element 74 of FIG. 3C).

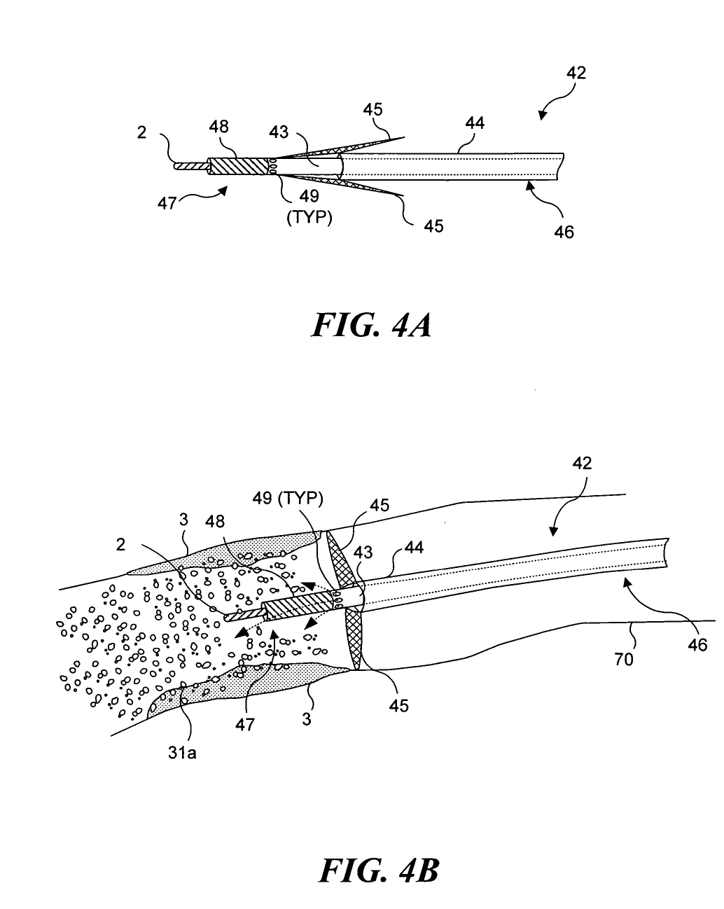

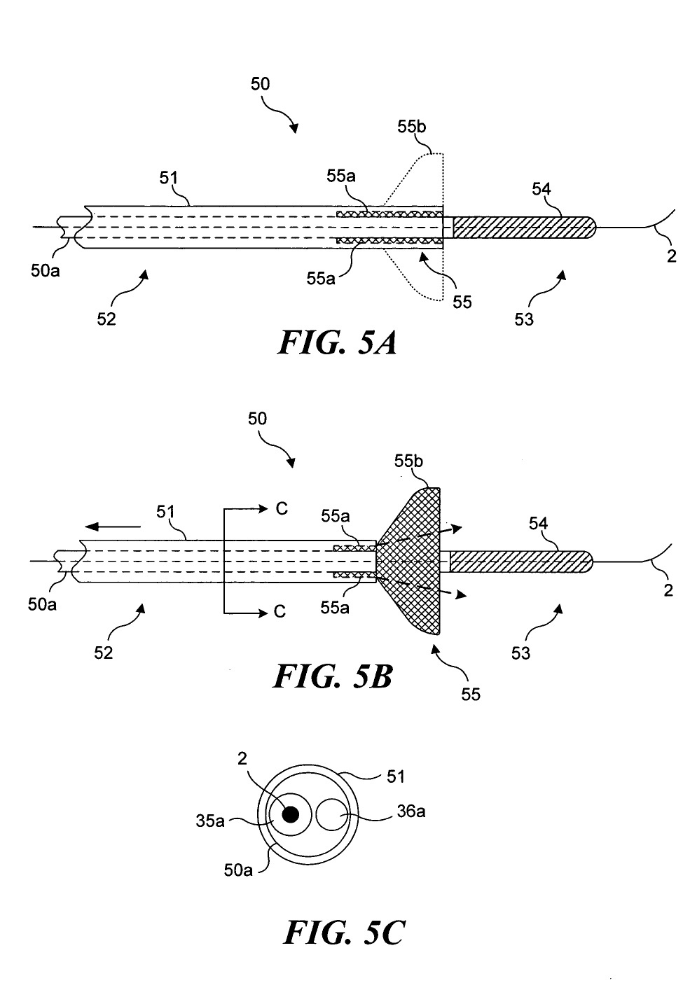

FIGS. 4A-4B and 5A-5C each relate to embodiments of the light-generating device, wherein the centering member is moved between the first position and the second position by moving an outer sheath of the light-generating device, while keeping an inner member of the light-generating device in a substantially fixed position. Once again, the centering members of these embodiments are preferably implemented using a substantially non porous material, such that the centering members also substantially occlude flow of bodily fluids that might interfere with the delivery of light to target tissue. If centering is desired without occlusion, then the centering members can be implemented using a porous material.

Referring to FIG. 4A, a light-generating device 42 including a centering member 45 is schematically shown. Once again, light-generating device 42 is employs a multi-lumen catheter having an elongate flexible body formed from a suitable biocompatible material, such as a polymer or metal. Light-generating device 42 has a proximal shaft 46 and a distal shaft 47. A light-generating array 48 is integrally included on distal shaft 47. Again, light-generating array 48 preferably includes one or more LEDs coupled to conductive traces that are electrically connected to leads extending proximally through a lumen of light-generating device 42 to an external power supply and control device (not shown). As an alternative to LEDs, other sources of light maybe used, as discussed above. Distal shaft 47 includes a plurality of ports 49 coupled in fluid communication with a flushing lumen (not separately shown, but described in detail above), to enable a flushing fluid to be introduced into a body lumen where light-generating device 42 is deployed. Ports 49 are disposed distal to centering member 45, which is described in greater detail below. As noted above, light-generating device 42 is intended to be used in body lumens where bodily fluid (e.g. blood) flows from a proximal portion of the apparatus toward a more distal portion. If the bodily fluid flow is in the opposite direction, ports 49 are disposed proximal of centering member 45. Again, if only centering is desired without occlusion, then centering member 45 simply needs to be disposed on a distal end of light-generating device 42.

Light-generating device 42 also includes an outer sheath 44 and an inner sheath 43. Centering member 45 preferably comprises a flexible mesh that substantially occludes a flow of bodily fluid when the mesh is deployed; the mesh is attached to both outer sheath 44 and inner sheath 43. A mesh coated with polyurethane or a similar polymer is particularly preferred for the centering member. Centering member 45 is attached to outer sheath 44 at a distal end of the outer sheath and is attached to inner sheath 43 adjacent to (and proximal of) ports 49. Outer sheath 44 can be moved independently of inner sheath 43, and in FIG. 4A, centering member 45 is illustrated in the first position (not occluding flow, and generally conforming to the device). To deploy centering member 45, outer sheath 44 is gradually advanced, while inner sheath remains substantially fixed in position, causing centering member 45 to move outwardly and away from light-generating device 42. When light-generating device 42 is disposed in a body lumen such as an artery, outer sheath 44 is advanced until the centering member contacts the walls of the artery, thus centering the distal end of light-generating device 42, and substantially interrupting the flow of blood in the artery. As noted above, if it is desirable to center the distal end of light-generating device 42 without also occluding the flow of bodily fluid, then the mesh of the centering member may not be coated with the polymer, so that the mesh does not substantially occlude bodily fluid flow, but instead, only centers the distal end of light-generating device 42 within the body lumen.

FIG. 4B schematically illustrates light-generating device 42 being used in artery 70. As described above, guidewire 2 has been inserted and advanced to lesion 3. Light-generating device 42 has been advanced over guidewire 2, and disposed adjacent to (and generally proximal of) lesion 3. Outer sheath 44 has been advanced distally, sufficiently far so as to cause centering member 45 to deploy and engage the walls of artery 70, substantially occluding blood flow distal of centering member 45. A flushing fluid 31a (such as saline, heparin, and/or a light scattering medium such as Intralipid) is introduced to artery 70 via ports 49, to displace any remaining blood adjacent to light-generating array 48. After the light treatment has been administered to provide the PDT, centering member 45 is returned to its original flattened state by withdrawing outer sheath 44 until centering member 45 substantially conforms to light-generating device 42.

FIGS. 5A and 5B illustrate still another implementation of a light-generating device including a centering member that is deployed by moving an outer sheath, while an inner sheath remains substantially fixed in position. While the outer sheath in FIGS. 4A, 4B, 5A, and 5B can be moved independently of the inner sheath, it may not be entirely possible to prevent movement of the outer sheath from imparting some small movement to the inner sheath. Thus, referring to the inner sheath as being substantially fixed in position should be understood to indicate that the inner sheath may move a small amount, but most of the motion is due to the change in position of the outer sheath. Once again, the centering member of such an embodiment is preferably implemented using a substantially non porous material, such that both centering and occlusion is achieved, but if centering alone is desired (without occlusion), then the centering member can be implemented using a substantially porous material.

Referring now to FIG. 5A, a light-generating device 50 is shown that has a proximal shaft 52 and a distal shaft 53. A light-generating array 54, substantially similar to those described above, is integrated into distal shaft 53, and a centering member 55 is coupled to distal shaft 53. Centering member 55 preferably comprises a thin polymer coated mesh umbrella formed of a shape memory material. Centering member 55 has two states, a compressed state 55a, and a deployed state 55b, corresponding to the first position (substantially no occlusion) and the second position (substantial occlusion), as discussed above. Light-generating device 50 also includes an outer sheath 51 and an inner body 50a. Outer sheath 51 is movable relative to inner body 50a. Before light-generating device 50 is introduced into a body lumen, for administering the PDA treatment, centering member 55 is in compressed state 55a, as shown in FIG. 5A. In this compressed state, outer sheath 51 covers centering member 55, forcing centering member 55 to remain compressed. To deploy centering member 55, outer sheath 51 is gradually withdrawn, enabling the shape memory material comprising the mesh to return to deployed state 55b, as indicated in FIG. 5B. Before light is delivered, the blood distal to centering member 55 is flushed away from the treatment site by delivering a flushing fluid through a flushing lumen, as described above.

FIG. 5C is a cross-sectional view of light-generating device 50, taken along section line C-C of FIG. 5B, illustrating that light-generating device 50 includes a guidewire lumen 35a and a flushing lumen 36a; the functions of these components have been described in detail above. Also shown are outer sheath 51 and inner body 50a.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

1. Apparatus for illuminating a portion of a body lumen, comprising:
(a) an elongate flexible body having a proximal end, a distal end, and at least one lumen extending therebetween;
(b) an array of light sources disposed adjacent to the proximal end of the elongate flexible body; and
(c) means that are not inflatable, for reducing an amount of bodily fluid adjacent to the array of light sources when the apparatus is positioned within the body lumen, thereby preventing light generated by the array of light sources from being absorbed by the bodily fluid, and increasing the light generated by the array of light sources that reaches a wall of the body lumen.

2. The apparatus of claim 1, further comprising an electrical lead having a proximal end adapted to be electrically coupled to an external power supply, and a distal end electrically coupled to the array of light sources, thereby enabling the array of light sources to be energized with an electrical current when the proximal end of the electrical lead is electrically coupled to an external power supply.

3. The apparatus of claim 1, wherein the array of light sources emits light having a characteristic emission waveband, where the characteristic emission band corresponds to a characteristic absorption waveband of a selected photoreactive agent.

4. The apparatus of claim 1, wherein the array of light sources comprises at least one light emitting diode.

5. The apparatus of claim 1, wherein the array of light sources is mounted on a flexible, conductive substrate encapsulated in silicone.

6. The apparatus of claim 1, wherein said means comprises a flushing lumen, the flushing lumen being adapted to convey a flushing fluid into the body lumen to displace a bodily fluid that might otherwise absorb light generated by the array of light sources.

7. The apparatus of claim 6, wherein the flushing lumen comprises at least one fluid port through which the flushing fluid is introduced into a body lumen, the at least one fluid port being disposed proximal of the array of light sources.

8. The apparatus of claim 6, wherein said means further comprises a centering member movable between at least a first position and a second position, the first position being characterized by the centering member generally conforming to the elongate flexible body, the second position being characterized by the centering member generally extending from the elongate flexible body to a wall of a body lumen, such that the centering member substantially occludes a flow of bodily fluid in a body lumen, and substantially centers the distal end within the body lumen.

9. The apparatus of claim 1, wherein said means comprises a centering member movable between a first position and a second position, the first position being characterized by the centering member generally conforming to the elongate flexible body, the second position being characterized by the centering member generally extending from the elongate flexible body to a wall of the body lumen, such that the centering member and substantially centers the distal end within the body lumen, and substantially occludes a flow of bodily fluid in the body lumen.

10. The apparatus of claim 9, wherein the centering member comprises a shape memory material, the shape memory material moving from the first position to the second position in response to a change in temperature of the shape memory material.

11. The apparatus of claim 10, wherein the centering member overlaps at least a portion of the array of light sources, so that energizing the array of light sources increases a temperature of the centering member, thereby causing the centering member to move to the second position as a result of a force produced by the shape memory material.

12. The apparatus of claim 10, further comprising a heating element disposed adjacent to the centering member, and an electrical lead having a proximal end adapted to be electrically coupled to an external power supply and a distal end electrically coupled to the heating element, thereby enabling the heating element to be energized with an electrical current when the proximal end of the electrical lead is electrically coupled to an external power supply, heat produced by the heating element causing the centering member to move to the second position as a result of a force produced by the shape memory material.

13. The apparatus of claim 9, wherein the elongate flexible body comprises an outer sheath and an inner member, and the centering member moves between the first position and the second position in response to a movement of the outer sheath relative to the inner member.

14. The apparatus of claim 13, wherein the centering member is attached to the inner member, and when the centering member is in the first position, the centering member is disposed between the outer sheath and the inner member, and wherein to cause the centering member to attain the second position, the outer sheath is moved in a proximal direction while the inner member remains relatively stationary.

15. The apparatus of claim 13, wherein the centering member is attached to the inner member and the outer sheath, and wherein to cause the centering member to attain the second position, the outer sheath is advanced distally, while the inner member remains relatively stationary.

16. The apparatus of claim 1, further comprising a centering member movable between a first position and a second position, the first position being characterized by the centering member generally conforming to the elongate flexible body, the second position being characterized by the centering member generally extending from the elongate flexible body to a wall of the body lumen, such that the centering member substantially centers the distal end within the body lumen.

17. Apparatus for illuminating a portion of a body lumen, comprising:
(a) an elongate flexible body having a proximal end, a distal end, and at least one lumen extending therebetween;
(b) an array of light sources disposed adjacent the proximal end of the elongate flexible body; and
(c) a centering member movable between at least a first position and a second position, the first position being characterized by the centering member generally conforming to the elongate flexible body, the second position being characterized by the centering member generally extending from the elongate flexible body to a wall of a body lumen, so that the centering member substantially centers the distal end of the elongate flexible body within a body lumen, the centering member being movable between the first and the second positions without applying a pressurized fluid to the centering member.

18. The apparatus of claim 17, wherein the centering member is substantially non porous, such that when the centering member is in the second position, the centering member substantially occludes a flow of a bodily fluid in a body lumen, thereby reducing a portion of light generated by the array of light sources that is absorbed by a bodily fluid, while increasing a remainder of the light generated by the array of light sources that reaches a wall of a body lumen.

19. The apparatus of claim 17, further comprising an electrical lead having a proximal end adapted to be electrically coupled to an external power supply, and a distal end electrically coupled to the array of light sources, thereby enabling the array of light sources to be energized with an electrical current when the proximal end of the electrical lead is electrically coupled to an external power supply.

20. The apparatus of claim 17, wherein the array of light sources comprises at least one light emitting diode.

21. The apparatus of claim 17, wherein the array of light sources is mounted on a flexible, conductive substrate encapsulated in a light transmissive polymer.

22. The apparatus of claim 17, wherein the elongate flexible body comprises a flushing lumen, the flushing lumen being adapted to introduce a flushing fluid into a body lumen to displace a bodily fluid that might otherwise absorb light generated by the array of light sources, the flushing lumen comprising at least one fluid port through which a flushing fluid is introduced into a body lumen, the at least one fluid port being disposed proximal of the array of light sources.

23. The apparatus of claim 17, wherein the centering member comprises a shape memory material, the shape memory material producing a force that causes the centering member to move from the first position to the second position, in response to a change in temperature of the shape memory material.

24. The apparatus of claim 23, wherein the centering member overlaps at least a portion of the array of light sources, so that energizing the array of light sources increases a temperature of the centering member, thereby causing the shape memory material to produce a force that moves the centering member to the second position.

25. The apparatus of claim 23, further comprising a heating element disposed adjacent to the centering member, the heating element producing heat that changes the temperature of the shape memory material, to selective apply a force to move the centering member to the second position.

26. The apparatus of claim 17, wherein the elongate flexible body comprises an outer sheath and an inner member, and the centering member moves between the first position and the second position in response to a movement of the outer sheath relative to the inner member.

27. The apparatus of claim 26, wherein when the centering member is in the first position, the centering member is disposed between the outer sheath and the inner member, and when moving the centering member to the second position, the outer sheath is moved in a proximal direction, while the inner member remains relatively stationary.

28. The apparatus of claim 26 wherein the centering member is attached to the inner member and the outer sheath, and when moving the centering member to the second position, the outer sheath is advanced distally, while the inner member remains relatively stationary.

29. A system for illuminating a portion of a body lumen, comprising:
(a) an intra lumen device comprising an elongate flexible body having a proximal end, a distal end, and a plurality of lumens, said plurality of lumens including at least a guidewire lumen, a flushing fluid lumen, and a working lumen;
(b) a guidewire adapted to be inserted into a body lumen, so that the intra lumen device can be advanced over the guidewire; and
(c) a light source element encapsulated in a biocompatible light transmissive material and configured to be advanced through the working lumen to the distal end of the intra lumen device, the light source element having a distal end and a proximal end, the distal end including at least one light source, the light source element being coupled to an electrical lead that is adapted to connect to an external power supply, to enable the light source element to be energized with an electrical current, causing the light source element to emit light having a characteristic emission waveband selected to administer photodynamic therapy.

30. The system of claim 29, wherein the guidewire lumen and the working lumen comprise a common lumen, so that the guidewire is removed from the common lumen to enable the light source element to be advanced distally through the common lumen.

31. The system of claim 29, wherein the distal end comprises a light diffusing tip.

32. The system of claim 29, wherein the intra lumen device further comprises a centering member movable between at least a first position and a second position, the first position being characterized by the centering member generally conforming to the intra lumen device, the second position being characterized by the centering member generally extending from the intra lumen device to a wall of a body lumen, so that the centering member substantially centers the distal end of the intra lumen device within the body lumen.

33. The apparatus of claim 32, wherein the centering member is substantially non porous, such that when the centering member is in the second position, the centering member substantially occludes a flow of a bodily fluid in a body lumen, thereby reducing a portion of light generated by the light source element that is absorbed by a bodily fluid, while increasing a remainder of the light generated by the light source element that reaches a wall of a body lumen.

34. A method for administering photodynamic therapy to vascular tissue, comprising the steps of:
(a) administering a photoreactive agent to a target vascular tissue in a patient, the photoreactive agent having a characteristic absorption waveband;
(b) advancing a vascular illumination apparatus through the vascular system of the patient until a light source is disposed adjacent to the vascular target tissue, the light source having a characteristic emission waveband corresponding to the characteristic absorption waveband of the photoreactive agent;
(c) carrying out at least one of the steps of:
(i) reducing an amount of bodily fluid adjacent to the light source without using an inflatable member, such bodily fluid absorbing at least a portion of the light emitted from the light source; and
(ii) substantially centering a distal end of the vascular illumination apparatus within a body lumen into which the vascular illumination apparatus has been advanced, the step of centering being achieved without use of a pressurized fluid; and
(d) energizing the light source to administer light to the vascular target tissue, resulting in at least one of a therapeutic effect, and a diagnostic state.

35. The method of claim 34, wherein the step of reducing the amount of bodily fluid adjacent to the light source comprises the step of introducing a flushing fluid into the vascular system generally adjacent to the light source, so that the flushing fluid substantially displaces the bodily fluid adjacent to the light source, said flushing fluid being substantially transparent to the light from the light source.

36. The method of claim 35, wherein the step of reducing the amount of bodily fluid adjacent to the light source further comprises the step of substantially occluding a flow of the bodily fluid adjacent to the light source.

37. The method of claim 34, wherein the step of reducing the amount of bodily fluid adjacent to the light source comprises the step of substantially occluding a flow of the bodily fluid adjacent to the light source.

38. The method of claim 37, wherein the step of substantially occluding the flow of the bodily fluid adjacent to the light source comprises the step of using a shape memory material to produce a force that moves a centering member so as to substantially occlude the flow of bodily fluid, the centering member being moved in response to the force produced by the shape memory material from a first position in which the flow of bodily fluid is substantially not occluded, to a second position in which the flow of bodily is substantially occluded, in response to a change in temperature of the shape memory material.

39. The method of claim 38, wherein the temperature of the shape memory material is changed by applying heat to the shape memory material.

40. The method of claim 39, wherein the step of applying heat to the shape memory material comprises the step of using heat produced by the light source.

41. The method of claim 39, wherein the step of applying heat to the shape memory material comprises the step of energizing a heating element disposed adjacent to the shape memory material to produce the heat.

42. The method of claim 37, wherein the step of substantially occluding the flow of the bodily fluid adjacent to the light source comprises the step of moving a first portion of the vascular illumination apparatus while keeping a second portion of the vascular illumination apparatus substantially fixed in position, to cause a centering member to move from a first position in which the flow is substantially not occluded, to a second position in which the flow is substantially occluded.

43. The method of claim 42, wherein the step of moving the first portion of the vascular illumination apparatus comprises the step of advancing the first portion of the vascular illumination apparatus further into the vascular system, until the centering member substantially contacts a wall of the vascular system.

44. The method of claim 42, wherein the step of moving the first portion of the vascular illumination apparatus while keeping the second portion of the vascular illumination apparatus substantially fixed in position comprises the step of gradually withdrawing the first portion of the vascular illumination apparatus from the vascular system, until the centering member substantially contacts a wall of the vascular system.

45. The method of claim 37, further comprising the step of introducing a flushing fluid into the vascular system generally adjacent to the light source, so that the flushing fluid substantially displaces any bodily fluid remaining adjacent to the light source.

46. The method of claim 34, wherein the step of substantially centering the distal end of the vascular illumination apparatus comprises the step of moving a centering member from a first position, in which the centering member substantially conforms to the vascular illumination apparatus, to a second position, in which the centering member substantially contacts a wall of the vascular system.

47. The method of claim 46, wherein the step of moving the centering member from the first position to the second position comprises the step of moving a first portion of the vascular illumination apparatus while keeping a second portion of the vascular illumination apparatus substantially fixed in position.

48. The method of claim 46, wherein the centering member comprises a shape memory material, and wherein the step of moving the centering member from the first position to the second position comprises the step of heating the shape memory material, causing the shape memory material to apply a force to the centering member.

49. A method for administering photodynamic therapy to vascular tissue, comprising the steps of:
(a) administering a photoreactive agent to a target vascular tissue in a patient, the photoreactive agent having a characteristic absorption waveband;
(b) advancing a vascular illumination apparatus through the vascular system of the patient until a light source is disposed adjacent to the vascular target tissue, the light source having a characteristic emission waveband corresponding to the characteristic absorption waveband of the photoreactive agent;
(c) substantially centering a distal end of the vascular illumination apparatus within a body lumen into which the vascular illumination apparatus has been advanced, the step of centering being achieved without use of a pressurized fluid; and
(d) energizing the light source to administer light to the vascular target tissue, resulting in at least one of a therapeutic effect, and a diagnostic state.

50. The method of claim 49, wherein the step of substantially centering the distal end of the vascular illumination apparatus comprises the step of moving a centering member from a first position, in which the centering member substantially conforms to the vascular illumination apparatus, to a second position, in which the centering member substantially contacts a wall of the vascular system.

51. The method of claim 49, wherein the centering member comprises a shape memory material, and wherein the step of moving the centering member from the first position to the second position comprises the step of heating the shape memory material, causing the shape memory material to apply a force to the centering member.

52. The method of claim 49, wherein the centering member is substantially non porous, and wherein the step of moving the centering member from the first position to the second position substantially occludes a flow of the bodily fluid adjacent to the light source.
